(19) United States
(12) Patent Application Publication
(10) Pub. No.: US 2019/0094093 A1
(43) Pub. Date: Mar. 28, 2019

(54) PRESSURE SENSOR PACKAGE AND ELECTRONIC DEVICE INCLUDING THE SAME

(71) Applicant: SENTOUS CO., Ltd., Seoul (KR)

(72) Inventor: Young-Jae Min, Hwaseong-si (KR)

(73) Assignee: SENTOUS CO., Ltd., Seoul (KR)

(21) Appl. No.: 15/819,062

(22) Filed: Nov. 21, 2017

(30) Foreign Application Priority Data
Sep. 25, 2017 (KR) 10-2017-0123730

(51) Int. Cl. G01L 15/00; G01L 9/00

(52) U.S. Cl. CPC G01L 15/00; G01L 9/0052

(57) ABSTRACT

According to an embodiment of the inventive concept, a pressure sensor package may be disposed in an inner space of an electronic device. The pressure sensor package may include a substrate in which a hole is defined, a pressure sensor disposed on one surface of the substrate to cover the hole and including a membrane, and an insulator disposed on the pressure sensor to cover at least a portion of the membrane. The pressure sensor may be disposed to detect a first pressure of the inner space of the electronic device, which is caused by air flowing through the hole, and a second pressure caused by an external force applied to the electronic device through the insulator.

### CROSS-REFERENCE TO RELATED APPLICATIONS

This U.S. non-provisional patent application claims priority under 35 U.S.C. § 119 to Korean Patent Application No. 10-2017-0123730, filed on Sep. 25, 2017, in Korean Intellectual Property Office, the entire contents of which are incorporated herein by reference.

### TECHNICAL FIELD

The present disclosure herein relates to a pressure sensor package and an electronic device.

### DESCRIPTION OF THE RELATED ART

As technologies are advanced, various electronic devices have been developed. In particular, various functions have been developed and added to portable electronic devices such as a smartphone. Various kinds of elements may be disposed in the electronic device to realize various functions. For example, a camera, a battery, a communication module, an antenna, a display, a touch pad, a mike, a speaker, a sensor, and the like may be disposed in the electronic device. Also, the electronic device may have a waterproof structure to prevent foreign substances (e.g., water) from penetrating into inside of itself.

For testing the waterproof structure of the electronic device, the electronic device may be directly dipped into water, or, alternatively, a sensor of the electronic device may be used for the test. Such a sensor may be used only for the test and may not be used for other purposes. That is, when an element is disposed in the electronic device only for the purpose of the test, the electronic device may increase in manufacturing cost and area.

### SUMMARY

An embodiment of the inventive concept provides a pressure sensor package that is disposed in an inner space of an electronic device. The pressure sensor package includes: a substrate in which a hole is formed; a pressure sensor disposed on one surface of the substrate to cover the hole and including a membrane; and an insulator disposed on the pressure sensor to cover at least a portion of the membrane. The pressure sensor is disposed to detect a first pressure of the inner space of the electronic device, which is caused by air flowing through the hole, and a second pressure caused by an external force applied to the electronic device through the insulator.

In an embodiment of the inventive concept, an electronic device that includes a housing for waterproof includes: a pressure sensor package configured to detect a first pressure inside the housing and a second pressure caused by an external force applied to the housing; and a processor configured to receive a detection result of the pressure sensor package.

### BRIEF DESCRIPTION OF THE FIGURES

FIG. 1 is a view exemplarily illustrating a cross-section of a pressure sensor package according to an embodiment of the inventive concept.

FIGS. 2 and 3 are views exemplarily illustrating a cross-section of the pressure sensor package when the pressure sensor package in FIG. 1 is disposed in an electronic device.

FIG. 4 is a view exemplarily illustrating a cross-section of a pressure sensor package disposed in an electronic device according to another embodiment of the inventive concept.

FIG. 5 is a view exemplarily illustrating a pressure sensor package according to another embodiment of the inventive concept.

FIG. 6 is a view exemplarily illustrating a cross-section of a pressure sensor package disposed in an electronic device according to another embodiment of the inventive concept.

FIG. 7 is a view exemplarily illustrating a cross-section of a pressure sensor package according to another embodiment of the inventive concept.

FIG. 8 is a view exemplarily illustrating a cross-section of an electronic device according to an embodiment of the inventive concept.

### DETAILED DESCRIPTION

Hereinafter, embodiments of the inventive concept are exactly and precisely described so that the present disclosure may be easily implemented by those with ordinary skill in the technical field of the present invention.

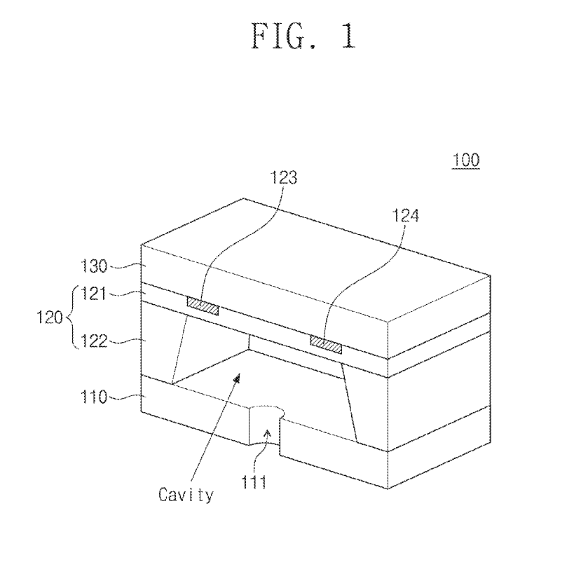

FIG. 1 is a view exemplarily illustrating a cross-section of a pressure sensor package according to an embodiment of the inventive concept. Referring to FIG. 1, a pressure sensor package 100 may include a substrate 110, a pressure sensor 120, and an insulator 130.

The substrate 110 may supply a power to the pressure sensor 120 and physically support the pressure sensor 120. The substrate 110 may receive an electric signal from the pressure sensor 120 and transmit a control signal to the pressure sensor 120. For example, the substrate 110 may be a lead frame or a printed circuit board.

Referring to FIG. 1, a hole 111 may be formed in the substrate 110. In more detail, the hole 111 may be formed by penetrating from a top surface to a bottom surface of the substrate 110. The substrate 110 may provide an air flow path to the pressure sensor 120 by using the hole 111 while supporting the pressure sensor 120. Although the hole 111 may have a shape illustrated in FIG. 1, an embodiment of the inventive concept is not limited thereto. For example, the hole 111 may have an arbitrary shape providing the air flow path to the pressure sensor 120.

The pressure sensor 120 may be disposed on the top surface of the substrate 110 to cover the hole 111. External air of the pressure sensor package 100 may be flowed into the pressure sensor 120 through the hole 111. The pressure sensor 120 may include a membrane 121 and a frame 122.

The membrane 121 may represent a thin layer formed in a process of manufacturing the pressure sensor 120. The membrane 121 may be easily bent by a pressure. The membrane 121 may be referred to as a diaphragm. The membrane 121 may be formed by depositing a polysilicon film or a silicon oxide film. For example, the membrane 121 may be an epitaxial layer.

The frame 122 may be a n-type silicon substrate, a p-type silicon substrate, or a glass substrate. The frame 122 may be disposed between the membrane 121 and the substrate 110. Here, the frame 122 may be partially etched so that a cavity between the membrane 121 and the substrate 110 is formed. When the cavity is formed through etching, the membrane 121 may be coupled to the outside of the pressure sensor package 100. Also, the cavity may be coupled to the outside of the pressure sensor package 100 through the hole 111.

Piezo elements 123 and 124 may be disposed on the membrane 121. The number of the piezo elements 123 and 124 may be equal to or greater than at least one. For example, the piezo elements 123 and 124 may be formed by injecting dopants into the membrane 121. When the membrane 121 is bent by a pressure, a stress of the membrane 121 may be transmitted to the piezo elements 123 and 124. Resistance values of the piezo elements 123 and 124 may be respectively varied by the stress of the membrane 121, and, through this, the pressure may be detected or measured.

In an embodiment, the piezo elements 123 and 124 may be formed or disposed on a position at which the stress of the membrane 121 may be maximally transmitted to the piezo elements 123 and 124. As illustrated in FIG. 1, the piezo elements 123 and 124 may be disposed on a position corresponding to a boundary between the cavity and the frame 122.

The insulator 130 may be disposed on a top surface of the pressure sensor 120. The insulator 130 may be implemented by using a flexible material that is bendable according to bending of the membrane 121. The insulator 130 may be disposed to cover the entire membrane 121 or the piezo elements 123 and 124 disposed on the membrane 121. That is, unlike the illustration in FIG. 1, the insulator 130 may be disposed to cover at least a portion of the membrane 121.

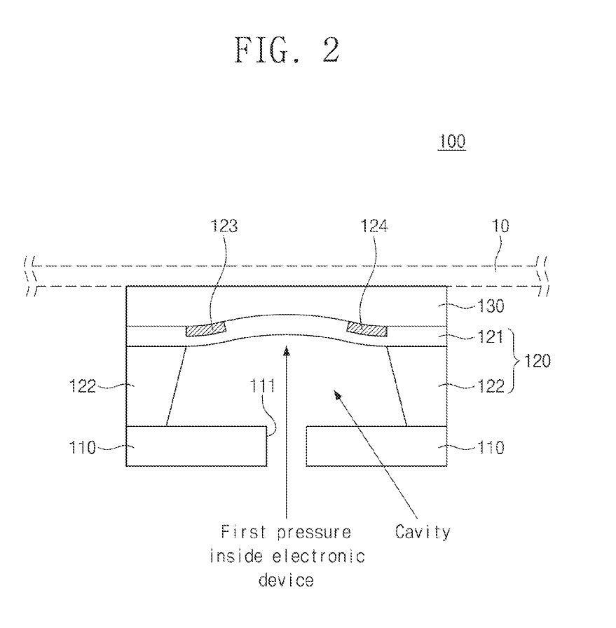

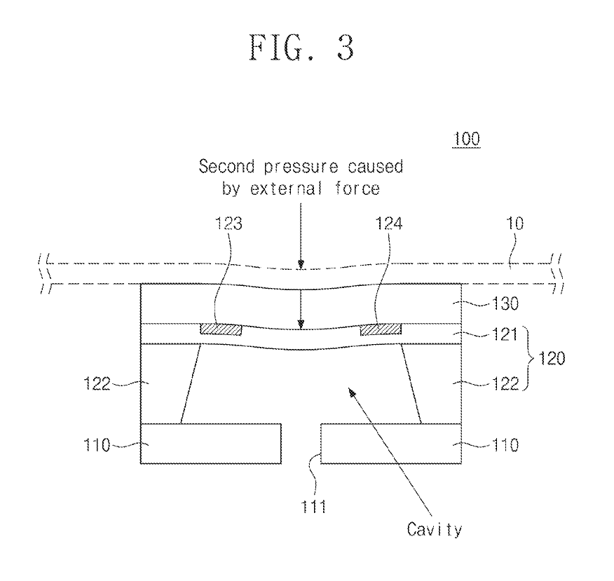

FIGS. 2 and 3 are views exemplarily illustrating a cross-section of the pressure sensor package when the pressure sensor package in FIG. 1 is disposed in an electronic device. Referring to FIGS. 2 and 3, the pressure sensor package 100 may be attached to an electronic device 10. In more detail, the insulator 130 of the pressure sensor package 100 may be attached to an inner surface or a bottom surface of the electronic device 10. The pressure sensor package 100 may be disposed in the electronic device.

In an embodiment, the electronic device 10 may include a housing. The inner surface of the electronic device 10 may be one surface of the housing. The housing may refer to an element surrounding or covering an electronic device to protect the electronic device. For example, the housing may include a cover, a case, a display, and a touch pad.

Referring to FIG. 2, the pressure sensor package 100 may detect a first pressure of an inner space of the electronic device by using air flowing through the hole 111. The first pressure may be formed by internal air of the electronic device. The first pressure may be an internal atmospheric pressure (or pneumatic pressure) of the electronic device. When the electronic device supports a waterproof function, the electronic device 10 may include a waterproof structure to prevent water from penetrating into the electronic device.

When there is a problem with a waterproof function of the electronic device due to a crack or assembly failure of the electronic device 10, the first pressure of the inner space of the electronic device may not be constantly maintained. For example, for testing the waterproof function of the electronic device, when a pressure is applied to an arbitrary position of the electronic device 10, the first pressure may be varied.

In more detail, when a pressure is applied in a direction from the outside to the inside of the electronic device, the membrane 121 may be bent in a direction toward the insulator 130 by the internal first pressure of the electronic device as illustrated in FIG. 2. The pressure sensor 120 may detect the varied first pressure. When there is no problem with a waterproof function of the electronic device, the first pressure may not be varied, and the membrane 121 may not be bent. That is, the waterproof function of the electronic device may be tested by using a detection result of the pressure sensor 120.

Referring to FIG. 3, the pressure sensor package 100 may detect a second pressure caused by an external force, which is applied to the electronic device 10, through the insulator 130. For example, the external force applied to the electronic device 10 may be generated by a touch of a user. In more detail, when the second pressure caused by an external force is applied to the electronic device 10, the electronic device 10 may be bent in a direction toward the insulator 130. Since the electronic device 10 may be generally implemented by using a rigid material to protect the electronic device, the electronic device 10 may be slightly bent by the second pressure.

A top surface of the insulator 130 may contact the electronic device 10 and a bottom surface of the insulator 130 may contact the pressure sensor 120 so that the second pressure is transmitted to the pressure sensor 120. Accordingly, the insulator 130 also may be bent together by the deformation of the electronic device 10 due to the second pressure, and the membrane 121 may be bent in a direction toward the substrate 110. That is, the pressure sensor 120 may detect the varied second pressure.

In FIG. 3, the insulator 130 directly contacts the electronic device 10. In another embodiment, unlike the illustration, the insulator 130 may not directly contact the electronic device 10. For example, another insulator may be disposed between the insulator 130 and the electronic device 10, or various elements of the electronic device 10 may be disposed therebetween. Even in this case, to receive the second pressure caused by an external force applied to the electronic device 10, the pressure sensor package 100 may be disposed inside the electronic device 10.

The pressure sensor package 100 may detect the second pressure caused by an external force and applied to the electronic device 10 through the insulator 130. According to an embodiment of the inventive concept, both of the first pressure and the second pressure may be detected by using one pressure sensor package 100. Accordingly, the electronic device may be reduced in area and manufacturing cost.

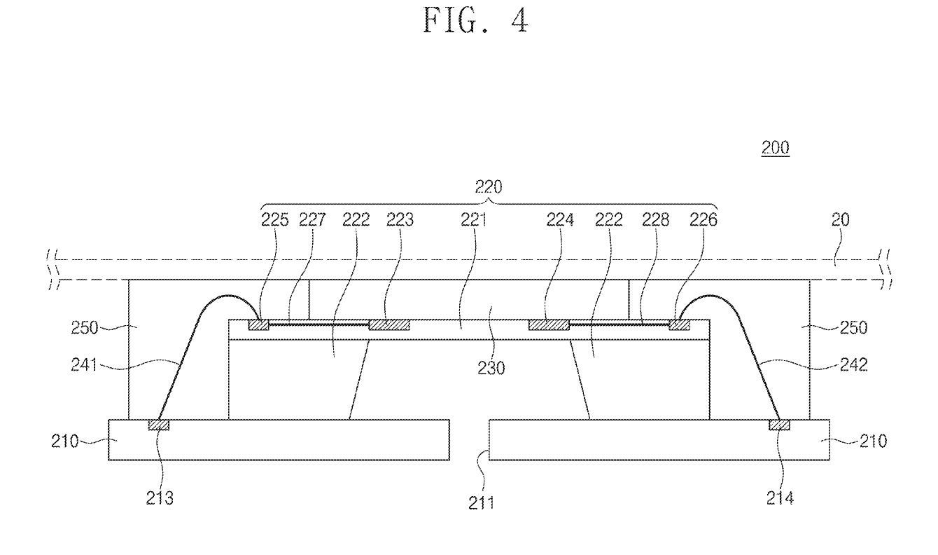

FIG. 4 is a view exemplarily illustrating a cross-section of a pressure sensor package disposed in an electronic device according to another embodiment of the inventive concept. Referring to FIG. 4, a pressure sensor package 200 may be attached to an electronic device 20. The pressure sensor package 200 may include a substrate 210, a pressure sensor 220, an insulator 230, and a molding resin 250. Hereinafter, a difference between the pressure sensor package 200 and the pressure sensor package 100 in FIG.1 will be mainly described.

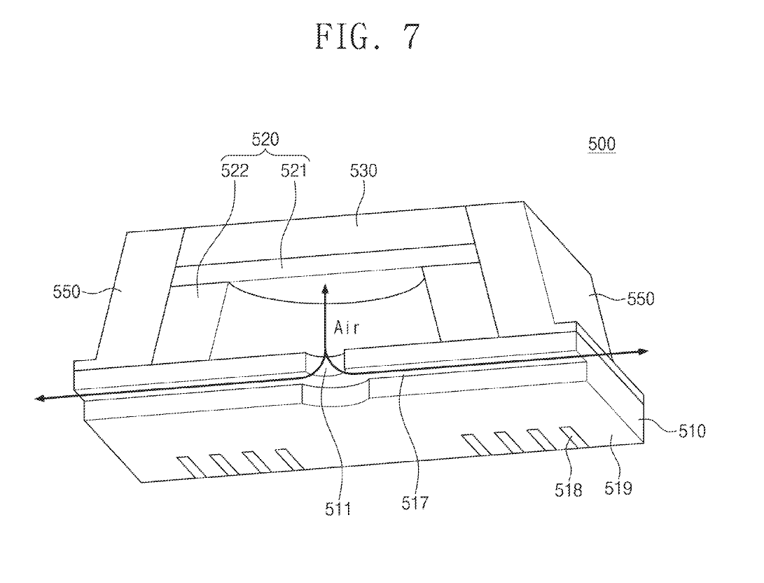

The substrate 210 may further include input terminals 213 and 214 in comparison with the substrate 110 in FIG. 1. The input terminals 213 and 214 may be implemented by using a metallic material and disposed on a top surface of the substrate 210. The input terminals 213 and 214 are terminals for receiving a detection result of the pressure sensor 220. Although not shown, the substrate 210 may further include output terminals electrically connected to the input terminals 213 and 214 and disposed on a bottom surface of the substrate 210. The output terminals will be described later in FIG. 7. The detection result of the pressure sensor 220 may be transmitted to elements (not shown) of the electronic device through the input terminals 213 and 214 and the output terminals.

The pressure sensor 220 may operate in the substantially same manner as that of the pressure sensor 120 in FIG. 1. The pressure sensor 220 may include a membrane 221 and a frame 222. The membrane 221 may further include output terminals 225 and 226 and wires 227 and 228 in addition to the piezo elements 223 and 224 in comparison with the membrane 121 in FIG. 1.

The output terminals 225 and 226 respectively receive variations of resistance values of the piezo elements 223 and 224 through the wires 227 and 228. To this end, the output terminals 225 and 226 are respectively connected to the piezo elements 223 and 224 through the wires 227 and 228. The output terminals 225 and 226 and the wires 227 and 228 may be formed on the silicon substrate (i.e., membrane 221) in a process of manufacturing the pressure sensor 120. An embodiment of the inventive concept is not limited to the number of the output terminals 225 and 226. For example, the number of the output terminals 225 and 226 may be equal to or greater than that of the piezo elements 223 and 224.

The pressure sensor package 200 may include conductive wires 241 and 242 respectively electrically connecting the output terminals 225 and 226 to the input terminals 213 and 214. The conductive wires 241 and 242 may be provided through a process of wire bonding. The detection result of the pressure sensor 220 may be transmitted to the substrate 210 through the wires 227 and 228, the output terminals 225 and 226, and the conductive wires 241 and 242.

The pressure sensor package 200 may further include the molding resin 250 in comparison with the pressure sensor 120 in FIG. 1. The molding resin 250 may seal and protect the pressure sensor 120 and the conductive wires 241 and 242. Here, the molding resin 250 may not cover a top surface of the insulator 230 so that the insulator 230 is attached to the electronic device 20. The top surface of the insulator 230 may be exposed to the outside, and a top surface of the molding resin 250 and the top surface of the insulator 230 may be disposed on the same plane.

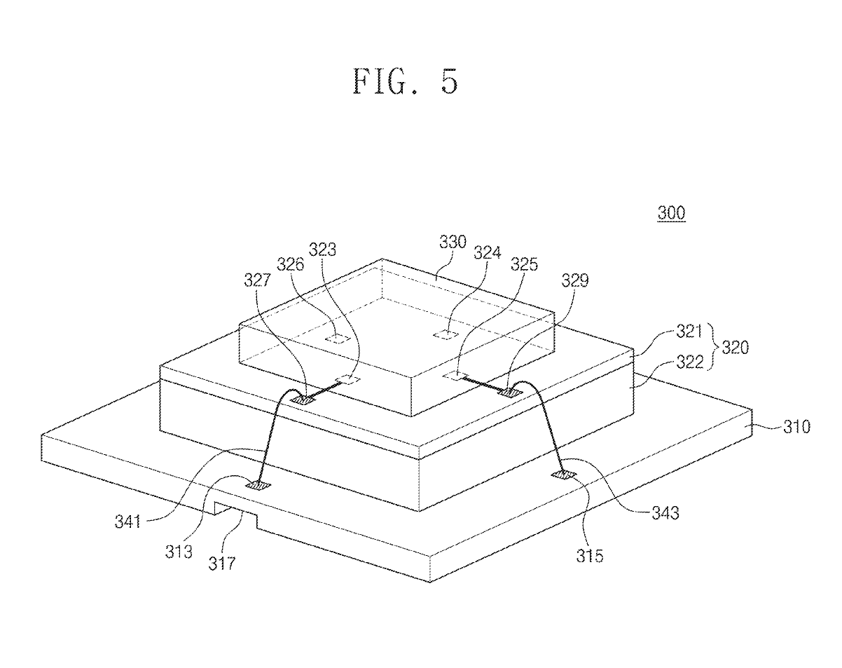

FIG. 5 is a view exemplarily illustrating a pressure sensor package according to another embodiment of the inventive concept. Referring to FIG. 5, a pressure sensor package 300 may include a substrate 310, a pressure sensor 320, and an insulator 330. The substrate 310, the pressure sensor 320, and the insulator 330 may be implemented in the substantially same manner as that of the substrate 110, the pressure sensor 120, and the insulator 130. Also, although the pressure sensor package 300 may include a molding resin, the molding resin is not illustrated.

The substrate 310 may include input terminals 313 and 315. The input terminals 313 and 315 may be implemented in the substantially same manner as that of the input terminals 213 and 214 in FIG. 4. An air flow path 317 may be formed in a bottom surface of the substrate 310. For example, the air flow path 317 may be formed by etching a portion of the bottom surface of the substrate 310 or by adding another substrate to the bottom surface of the substrate 310.

Although not shown, a hole may be formed in the substrate 310 in similar to the substrate 110 in FIG. 1, and such a hole may be coupled to the air flow path 317. Accordingly, external air of the pressure sensor package 300 may be flowed to the pressure sensor 320 through the hole defined in a top surface of the substrate 310 and the air flow path 317 formed in the bottom surface of the substrate 310.

The pressure sensor 320 may include a membrane 321 and a frame 322, and the membrane 321 may include piezo elements 323 to 326 and output terminals 327 and 329. The number of the piezo elements 323 to 326 disposed on the membranes 321 may be four. The piezo elements 323 to 326 may be implemented in the substantially same manner as that of the piezo elements 123 and 124 in FIG. 1. A wheatstone bridge circuit may be implemented by using the piezo elements 323 to 326.

The output terminals 327 and 329 may be connected to the piezo elements 323 to 326. Unlike the illustration, the number of the output terminals 327 and 329 may be equal to or greater than that of the piezo elements 323 to 326.

The conductive wires 341 and 343 may respectively connect the output terminals 327 and 329 to the input terminals 313 and 315. The conductive wires 341 and 343 may be implemented in the substantially same manner as that of the conductive wires 241 and 242 in FIG. 4.

The insulator 330 may be disposed on a top surface of the membrane 321 to cover the piezo elements 323 to 326. The insulator 330 may be implemented in the substantially same manner as that of the insulator 130 in FIG. 1. A top surface of the insulator 330 may contact a bottom surface (not shown) of an electronic device.

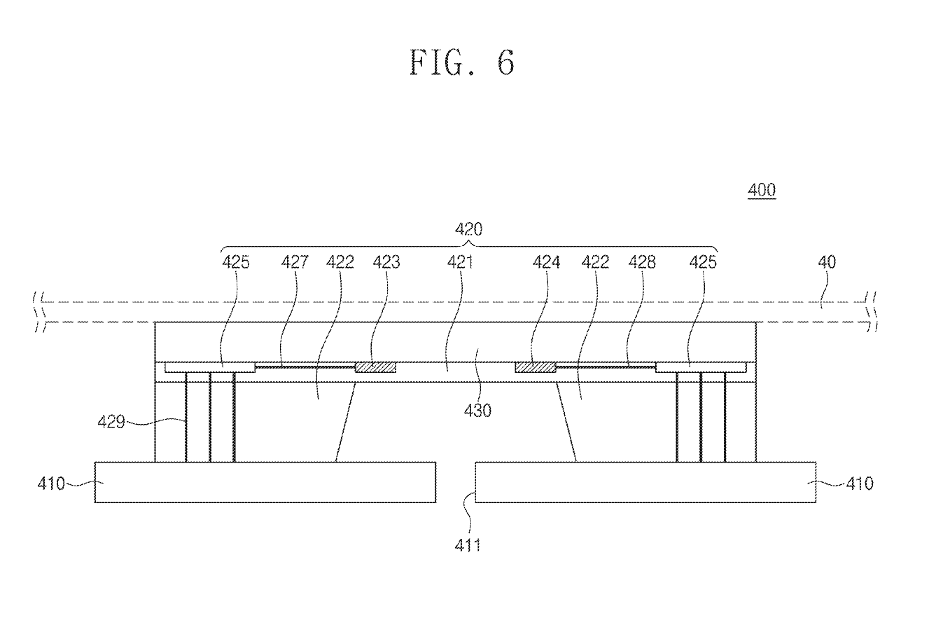

FIG. 6 is a view exemplarily illustrating a cross-section of a pressure sensor package disposed in an electronic device according to another embodiment of the inventive concept. A pressure sensor package 400 may include a substrate 410, a pressure sensor 420, and an insulator 430. The substrate 410, the hole 411, and the insulator 430 may be implemented in the substantially same manner as that of the substrate 110, the hole 111, and the insulator 130, respectively. The pressure sensor package 400 may be attached to an electronic device 40. Hereinafter, a difference between the pressure sensor package 400 and the pressure sensor package 200 in FIG. 4 will be mainly described.

The pressure sensor 420 may include a membrane 421 and a frame 422. The frame 422 may be implemented in the substantially same manner as that of the frame 222 in FIG. 4. Piezo elements 423 and 424 may be disposed on the membrane 421 in similar to the membrane 221 in FIG. 4. In comparison with the membrane 221 in FIG. 4, an electronic circuit 425 and wires 427 and 428 may be further disposed on the membrane 421.

The electronic circuit 425 may be implemented on a silicon substrate (i.e., membrane 421). The electronic circuit 425 may be connected to the piezo elements 423 and 424 through the wires 427 and 428. The electronic circuit 425 may receive and process variations of resistance values of the piezo elements 423 and 424 in a form of a voltage or a current. Also, the electronic circuit 425 may supply a power to the piezo elements 423 and 424 and control the piezo elements 423 and 424. For example, the electronic circuit 425 may be a processor.

A through-silicon via (TSV) 429 penetrating the membrane 421 and the frame 422 may be formed in the pressure sensor 420. The TSV 429 may connect the electronic circuit 425 and the substrate 410. The TSV 429 may be a path for supplying a power to the electronic circuit 425 or an input and output path for the electronic circuit 425.

FIG. 7 is a view exemplarily illustrating a cross-section of a pressure sensor package according to another embodiment of the inventive concept. Referring to FIG. 7, a pressure sensor package 500 may include a substrate 510, a pressure sensor 520, an insulator 530, and a molding resin 550. The pressure sensor 520 may include a membrane 521 and a frame 522. The pressure sensor 520, the membrane 521, the frame 522, the insulator 530, and the molding resin 550 may be implemented in the substantially same manner as that of the pressure sensor 220, the membrane 221, the frame 222, the insulator 230, and the molding resin 250, respectively.

A hole 511 may be formed in a top surface of the substrate 510, and the hole 511 and an air flow path 517 may be formed in a bottom surface 519 of the substrate 510. The air flow path 517 may be implemented similarly to the air flow path 317 in FIG. 5. The bottom surface of the substrate and the air flow path 517 may not be disposed on the same plane. When the bottom surface 519 of the substrate contacts a board of an electronic device, the air flow path 517 may not contact the board of the electronic device. Along an arrow illustrated in FIG. 7, air may move or flow between a cavity of the pressure sensor 520 and the outside of the pressure sensor package 500 through the hole 511 and the air flow path 517.

An output terminal 518 may be formed on the bottom surface of the substrate. Through the output terminal 518, a detection result of the pressure sensor 520 may be transmitted to elements (e.g., a processor and a storage device) of the electronic device. When the substrate 510 is disposed on the board of the electronic device, the output terminal 518 may contact an input terminal disposed on the board of the electronic device. An embodiment of the inventive concept is not limited to the number and shape of the output terminal 518 illustrated in FIG. 7.

In an embodiment, the output terminal 518 may have a ball shape (i.e., ball grid array (BGA)). When the pressure sensor package 500 is disposed on another substrate, the bottom surface 519 of the substrate may not contact another substrate due to a thickness of the output terminal 518. In such a case, since air may flow between the output terminals 518, the air flow path 517 may not be formed in the bottom surface 519 of the substrate. That is, the substrate 510 may be implemented to transfer the air to the cavity of the pressure sensor 520.

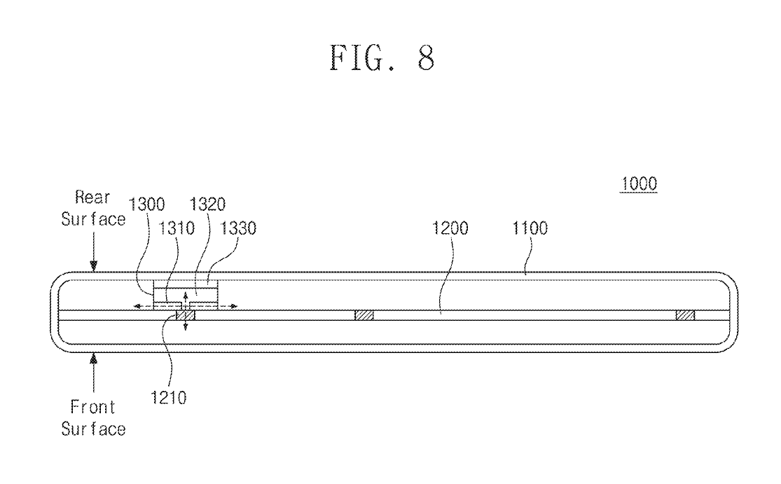

FIG. 8 is a view exemplarily illustrating a cross-section of an electronic device according to an embodiment of the inventive concept. Referring to FIG. 8, an electronic device 1000 may include a housing 1100, a printed circuit board 1200, and a pressure sensor package 1300.

For example, the electronic device 1000 may be one of a smartphone, a wearable device, a tablet PC, a mobile phone, a desktop PC, a laptop PC, a personal digital assistant (PDA), a portable multimedia player (PMP), a camera, a MP3 player, or the like.

The housing 1100 may surround and protect elements (not shown) of the electronic device 1000. For example, the elements may include a processor, a storage device, a communication module, a camera, a battery, a mike, a speaker, various sensors, and an interface circuit. The elements of the electronic device 1000 may be disposed on the printed circuit board 1200.

Referring to FIG. 8, the pressure sensor package 1300 may be disposed between the housing1100 and the printed circuit board 1200. The pressure sensor package 1300 may include a substrate 1310, a pressure sensor 1320, and an insulator 1330.

The substrate 1310 may be attached to one surface of the printed circuit board 1200. Here, as illustrated in FIG. 8, a hole of the substrate 1310 may be disposed at a position of a hole 1210 of the printed circuit board 1200. Also, the air flow path 517 that is described above in FIG. 7 may be formed in a bottom surface of the substrate 1310. Accordingly, in a direction of an arrow, inner air of the electronic device 1000 may flow into the pressure sensor package 1300, or inner air of the pressure sensor package 1300 may flow into the electronic device 1000.

The pressure sensor package 1300 may detect a pressure of an inner space of the electronic device 1000. At least one hole may be formed in the printed circuit board 1200 so that the pressure sensor package 1300 may detect the pressure of the inner space of the electronic device 1000.

The insulator 1330 may be disposed between the housing 1100 and the pressure sensor 1320. Accordingly, the insulator 1330 may transmit a pressure applied to the housing 1100 to the pressure sensor 1320. Thus, the pressure sensor package 1300 may detect an external force applied to the housing 1100. The pressure sensor package 1300 may transmit the detection result to the element of the electronic device 1000, through the substrate 1310 and the printed circuit board 1200. For example, the processor may be configured to receive the detection result of the pressure sensor package 1300.

In an embodiment, the pressure sensor package 1300 may be disposed on an arbitrary portion of a rear surface of the housing 1100. When the electronic device 1000 is a smartphone, the pressure sensor package 1300 may be disposed adjacent to a camera that is disposed on a rear surface of the pressure sensor package 1300.

According to the embodiment of the inventive concept, both of the pressure of the inner space of the electronic device and the pressure applied from the outside may be detected by using one pressure sensor package. Thus, the electronic device may be reduced in area and manufacturing cost.

The above-described contents are exemplary embodiments for implementing the present disclosure. Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A pressure sensor package that is disposed in an inner space of an electronic device, comprising:
a substrate in which a hole is formed;
a pressure sensor disposed on one surface of the substrate to cover the hole and comprising a membrane; and
an insulator disposed on the pressure sensor to cover at least a portion of the membrane,
wherein the pressure sensor is disposed to detect a first pressure of the inner space of the electronic device, which is caused by air flowing through the hole, and a second pressure caused by an external force applied to the electronic device through the insulator.

2. The pressure sensor package of claim 1, wherein the substrate is configured to receive a detection result of the pressure sensor.

3. The pressure sensor package of claim 1, wherein the substrate is a lead frame or a printed circuit board.

4. The pressure sensor package of claim 1, wherein an air flow path coupled to the hole is further formed in the other surface of the substrate.

5. The pressure sensor package of claim 4, wherein, when the other surface of the substrate contacts a substrate of the electronic device, the air flow path is not in contact with the substrate of the electronic device.

6. The pressure sensor package of claim 1, wherein to transmit the second pressure to the pressure sensor, one surface of the insulator contacts an inner surface of the electronic device and the other surface of the insulator contacts the pressure sensor.

7. The pressure sensor package of claim 6, wherein the electronic device comprises a housing, and
the inner surface of the electronic device is one surface of the housing.

8. The pressure sensor package of claim 1, wherein the pressure sensor comprises:
at least one piezo element disposed on the membrane; and
a frame disposed between the membrane and the substrate so that a cavity coupled to the inner space of the electronic device through the hole is formed.

9. The pressure sensor package of claim 7, wherein the membrane is bent in a direction toward the insulator by the first pressure or bent in a direction toward the substrate by the second pressure.

10. An electronic device that comprises a housing for waterproof, comprising:
a pressure sensor package configured to detect a first pressure inside the housing and a second pressure caused by an external force applied to the housing; and
a processor configured to receive a detection result of the pressure sensor package.
